(19) United States
(12) Patent Application Publication
(10) Pub. No.: US 2003/0012286 A1
(43) Pub. Date: Jan. 16, 2003

(54) Method and device for suspecting errors and recovering macroblock data in video coding

(75) Inventors: Faisal Ishtiaq, Chicago, IL (US); Bhavan Gandhi, Vernon Hills, IL (US); Kevin O'Connell, Palatine, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/902,124

(22) Filed: Jul. 10, 2001

(51) Int. Cl. H04N 7/12

(52) U.S. Cl. 375/240.27; 375/240.24

(57) ABSTRACT

A method and device for detecting errors in a digital video signal comprising a sequence of image frames, each image frame comprising a sequence of image slices, each image slice comprising a sequence of macroblocks and each macroblock comprising a plurality of pixels. A macroblock decoder includes an error detection unit that operates to calculate an error metric between pixel values on at least part of the boundary between a current macroblock and one or more adjoining macroblocks and to label the current macroblock as suspicious if the error metric is greater than a threshold level. The threshold level is adjusted according to a weighted average error metric from one or more previous image frames. Suspicious macroblocks and subsequent inter-coded macroblocks may be regenerated according to a concealment strategy if a syntax error is found within the current image slice.

### TECHNICAL FIELD

This invention relates to the field of image and video coding, and in particular to the areas of error detection and data recovery while decoding a bitstream with errors.

### BACKGROUND OF THE INVENTION

Transmission and storage of raw digital video requires a large amount of bandwidth. Video compression is necessary to reduce the bandwidth to a level suitable for transmission over channels such as the Internet and wireless links. H.263, H.261, MPEG-1, MPEG-2, and MPEG-4 international video coding standards, as described in

ITU-T Recommendation H.263, “Video Coding for Low Bitrate Communication”, January 1998,

ISO/IEC 13818-2, “MPEG-2 Information Technology—Generic Coding of Moving Pictures and Associated Audio—Part 2: Video”, 1995, and

ISO/IEC 14496-2, “MPEG-4 Information Technology—Coding of Audio-Visual Objects: Visual (Draft International Standard)”, October 1997, provide for a syntax for compressing the original source video allowing it to be transmitted or stored using a fewer number of bits. These video coding methods serve to reduce redundancies within a video sequence at the risk of introducing coding loss. The resulting compressed bitstream is much more sensitive to bit errors. When transmitting the compressed video bitstream in an error prone environment the decoder must be resilient in its ability to handle and mitigate the effects of these bit errors. This requires the need for a robust decoder capable of resolving errors and handling them adeptly.

The H.263, H.261, MPEG-2, and MPEG-4 video coding standards are all based on hybrid motion-compensated, discrete cosine transform (MC-DCT) coding. In their basic mode of operation these video coding standards operate on blocks of pixel data commonly referred to as blocks. These blocks form to generate macroblocks that, in turn, form to generate a group of blocks (GOB), or slice, that make up the frame. This will be discussed in more detail later with reference to FIG. 1. Within the video coding standards, compression is based on estimating the motion between successive frames, creating a motion-compensated estimate of the current frame, and computing a numerical difference, or residual, between the estimate and the original frame as shown in FIG. 2, which is discussed in more detail below. The residual is then DCT transformed and quantized (Q) in order to reduce the amount of information. Information transmitted in the compressed bitstream includes motion information, quantized transformed residual data, and administrative information needed for the reconstruction. A majority of this information is then entropy coded, using variable length coding (VLC) to reduce further the bit representation of the video. The bit representation is referred to as a compressed video bitstream.

The decoder operates on the compressed video bitstream to decode the compressed data and regenerate the video sequence. This will be discussed in more detailed below with reference to FIG. 3. The compressed bitstream is highly sensitive to bit errors that may severely impact decoding. Errors corrupting the administrative information may cause coding modes and sub-modes to be inadvertently activated or deactivated. Errors in the variable length coded information may cause codewords to be misinterpreted or deemed illegal, which may result in the decoder no longer knowing exactly where a variable length codeword begins or ends. This is referred to as the loss in synchronization between the decoder and the variable length codewords in the bitstream. Once synchronization between decoder and the bitstream is lost, the decoder will continue to decode what it believes is valid data until an illegal or invalid data is decoded. Hence, while it is possible to detect the location of an illegal codeword or data, it is not possible to detect the exact location of the error or how much data has been erroneously decoded. (See, for example, M. Budagavi, W. R. Heinzelman, J. Webb, and R. Talluri, “Wireless MPEG-4 Video Communication on DSP Chips”, IEEE Signal Processing Magazine, Vol. 17, pages 36-53, January 2000.)

This is a common scenario in video transmission over error prone channels and is shown in FIG. 4, which is a diagrammatic representation of the time relationship between the occurrence of an error and the detection of an error. The loss of synchronization causes the decoder to continuously decode an error even if subsequent data is error free. Single bit errors have the potential of causing severe damage to the current frame and subsequent frames due to the predictive nature of compression in the video coding standards.

To combat errors and to limit the loss of synchronization to a localized area, resynchronization markers, 302 and 304 in FIG. 4, are used to encapsulate the compressed bitstream into parts. These markers occur at the beginning of a group of blocks (GOB) 300 or at the start of a slice and are placed at the discretion of the encoder. An error or burst of errors, 306, occurring within a given slice 300 will not be detected until a later time 308 and will lead to the loss in synchronization within the slice. The errors are commonly handled by discarding the data for the entire slice and initiating a concealment strategy. While being prudent, discarding the entire slice also results in discarding data that has already been correctly decoded before the occurrence of the error. Effective error detection is an essential component of handling errors in the bitstream while retaining the maximum amount of correctly decoded information and is addressed by this invention.

Syntax checking is the most straightforward method for detecting errors. If an illegal codeword or data field is decoded within a slice or GOB, the entire slice or GOB is discarded and concealed. While being direct, this leads to losing the entire slice of data even though the error may have only corrupted a small part of the GOB or slice. Valid data that has been decoded up to the point of the error will essentially be thrown away. This leads to data loss and has prompted the development of more effective methods for detecting errors.

Content-based error detection utilizes the decoded data in order to determine whether or not it has been decoded in error. Recent works in literature have focused on using the intersample difference between blocks with fixed thresholds. Y-L. Chen and D. W. Lin, “Error Control for H.263 Video Transmission Over Wireless Channels”, IEEE International Symposium on Circuits and Systems ISCAS, Vol. 4, pages 118-121. IEEE 1998, present a technique for recovering the DC component of a block by testing whether or not the intersample difference is significant across a majority of the pixels along the block boundary. If the intersample differences exceed a predefined threshold, it is assumed that the DC component has been corrupted, and the DC component is replaced with the average of the DC values of neighboring blocks. This technique focuses mainly on concealing the DC component and the static threshold is determined experimentally.

W-J. Chu and J-J. Leou, “Detection and Concealment of Transmission Errors in H.261 Images”, IEEE Trans. On Circuits and Systems for Video Technology, Vol. 8, pages 74-84, February 1998, present a similar technique for detecting transmission errors in H.261 video. This method uses a combination of four measures in detecting an error. They are the average intersample difference within a block, the average intersample difference across block boundaries, the average mean difference, and the average variance difference. A weighted combination of the four measures is compared to a fixed threshold to make a determination as to whether or not an error has occurred within the current block. The fixed thresholds are based upon the statistics of the video and are constant over the video sequence. In addition to the drawbacks of using fixed thresholds, the computational overhead needed for each of the four measures for every block within a frame can be a limiting factor especially in applications where speed and/or computational efficiency are important.

A. Hourunranta, “Error Detection in Low Bit-Rate Video Transmission”, European Patent Application EP 0 999 709 A2, October 1999, details a three-step method for detecting errors in video bitstreams. This method checks the DCT matrix of a block, correlation between neighboring blocks, and the macroblock parameters. At each step a threshold is used. Each block is processed by the first step, if the block fails this check, it is then marked as being in error. Blocks that pass the first test are then subjected to the second check. Those that pass the second check are labeled as being without errors. Those that fail are labeled as being in error, while those that fail to meet the criteria of either passing or failing are labeled suspicious and forwarded to the third check. In the second check, the correlation between neighboring blocks is calculated as the sum of the minimum of the difference between the extrapolated pixel values on both sides of the block boundary and the actual pixel values. The sum of the minimum difference is compared to a predefined threshold to test whether the block is suspected to have been in error. If the sums of the difference exceed the threshold over all boundaries, the block is labeled to be in error. If a macroblock is marked suspicious it is then passed to the third detection stage otherwise it is labeled as an error-free block. In this error detection technique, the decoder may perform up to three tasks per macroblock. This can add extra computational burdens on the decoder. The second check involves extrapolating the pixel values on both sides of the edges for each boundary pixel. This can be an intensive operation if it is to be done for each boundary pixel of every block of every macroblock in every frame. Furthermore, hardware implementation of this type detection mechanism may cause pipelining delays.

M. R. Pickering, M. R. Frater and J. F. Arnold, “A Statistical Error Detection Technique for Low Bit-rate Video”, IEEE TENCON—Speech and Image Technologies for Computing and Telecommunications, 1997, describe a two stage error detection method applied to both pixels and DCT coefficients in each block. The mean edge pixel differences for each block of 8×8 pixels are compared with the standard deviation of mean edge pixel differences from the preceding frame. If the mean edge pixel difference exceeds the threshold, an error is flagged. Similarly, each of the 64 DCT coefficients within the block is compared to its respective standard deviation threshold. An error is flagged if a coefficient exceeds a multiple of the standard deviation for that coefficient. Generally, the mean value of the mean edge pixel differences will be greater than zero. Since the relationship between the mean value and the standard deviation will vary according to the video content, the statistical significance of comparing the mean edge pixel difference to the standard deviation is unclear. The computational load of this approach is also high. Furthermore, in this approach, concealment is initiated immediately if any of the checks fail. However, it is reasonable to expect the checks to fail in error free conditions such as at object boundaries, highly textured regions, in occluded regions, and when objects enter or leave the frame. In these error-free instances it is not prudent to flag an error and conceal the remaining slice or GOB. While this approach provides with adapted thresholds, the computational burden is high and the statistics of the comparison are not clear.

In light of the foregoing, there is an unmet need in the art for a computationally efficient method for suspecting errors within a decoded macroblock and recovering valid macroblock data from slices or GOB that would otherwise be discarded.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a diagrammatic representation of the elements constituting a frame of digital video data.

FIG. 2 is a simplified block diagram of an exemplary block-based video coder.

FIG. 3 is a simplified block diagram of an exemplary block-based video decoder.

FIG. 4 is a diagrammatic representation of an exemplary time relationship between the occurrence of an error and the detection of an error in a slice or GOBs.

FIG. 5 shows the regions of a macroblock and neighboring macroblocks used for error detection, according to one embodiment of the present invention.

FIG. 6 is a diagrammatic representation of the time relationship between the detection of an error and retained data according to the present invention.

FIG. 7 is a flow chart illustrative of one embodiment of the method of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

One aspect of the invention is a method for suspecting errors within a decoded macroblock and recovering data believed to have been decoded correctly within a GOB or a slice. It overcomes the shortcomings of the prior art by providing a computationally efficient adaptive mechanism that adjusts itself to the video content without the need for multiple detection steps or checks over the same data. It is a content-based technique that aims to ascertain whether a macroblock has been erroneously decoded. By adapting the threshold, this method allows the decoder to work robustly even in the presence of scene changes. This is in contrast to using fixed thresholds, where scene changes alter the statistics of the video, rendering the threshold inefficient. In a fixed threshold environment it is not possible to select the threshold based on the statistics of the video being transmitted. Ensemble statistics of previous or representative sequences are used to generate the threshold that can be inefficient and may not match the statistics of the video being transmitted.

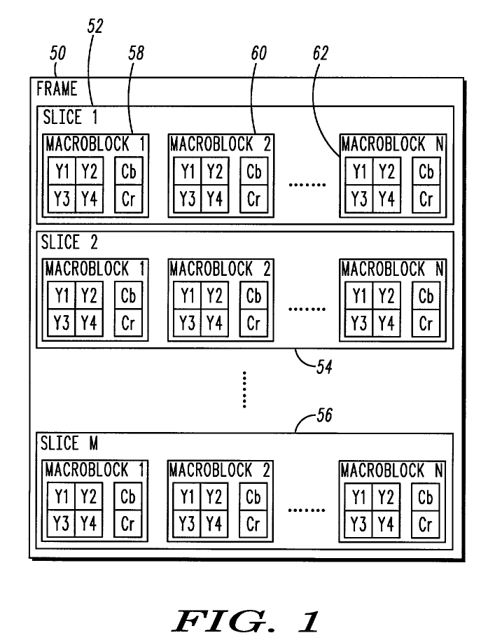

The relationships between the frames, slices, GOBs, and macroblocks of a digital video signal are shown in FIG. 1. A slice is composed of a group of consecutive macroblocks in raster scan order while a GOB is a subset of a slice that contains an entire row of macroblocks beginning at the left edge of the frame and ending at the right edge of the frame. Referring to FIG. 1, each frame 50 comprises a number of horizontal slices, 52, 54, 56, and each slice comprises a number of macroblocks 58, 60, 62 etc. In the 4:2:0 example shown here, each macroblock comprises four luminance blocks, Y1, Y2, Y3 and Y4, and two chrominance or color difference blocks, Cb and Cr. The luminance blocks, Y1, Y2, Y3 and Y4, correspond to the luminance values of the pixels within each 16×16 pixel region of the picture. The two chrominance blocks, Cb and Cr, denote the color-difference values of every other pixel in the 16×16 pixel region.

In other video formats, other color channel components such as the red, green and blue (R, G, B) or Y, U, and V (Y, U, V) components may be used in place of the components (Y, Cb, Cr). The present invention may additionally be used with a system having more than three channels, such as a four channel or a six channel system.

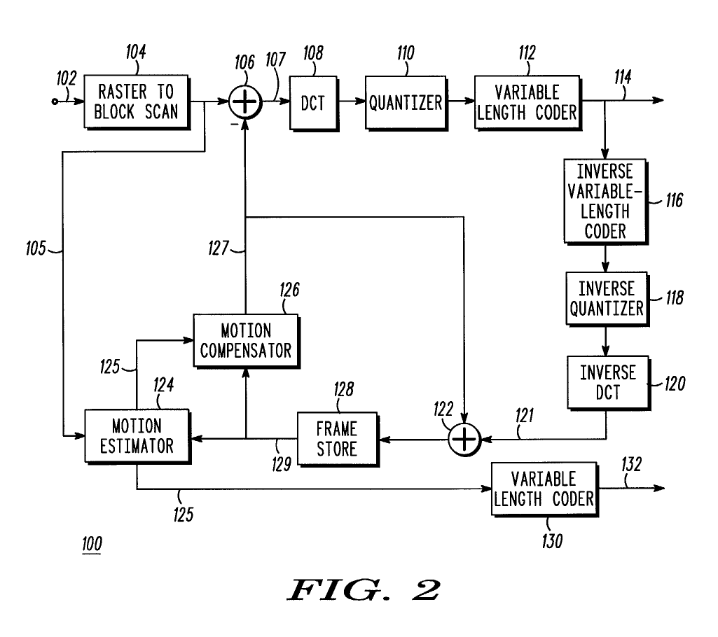

FIG. 2 is a simplified block diagram of an exemplary block-based video coder 100 configured for inter-coding macroblocks. The input 102 is typically a sequence of values representing the luminance (Y) and color difference (Cr and Cb) components of each pixel in each image. The sequence of pixels may be ordered according to a raster (line by line) scan of the image. At block 104 the sequence of pixels is reordered so that the image is represented as a number of macroblocks of pixels. In a 4:2:0 coding system, for example, each macroblock is 16 pixels by 16 pixels. In video, the images often change very little from one images to the next, so many coding schemes use inter-coding, in which a motion compensated version 127 of the previous image is subtracted from the current image at 106, and only the difference image 107 is coded. The luminance (Y) macroblock is divided into four 8×8 sub-blocks, and a Discrete Cosine Transform (DCT) is applied to each sub-block at 108. The color difference signals (Cb and Cr) are sub-sampled both vertically and horizontally and the DCT of the resulting blocks of 8×8 pixels is applied at 108. The DCT coefficients are quantized at quantizer 110 to reduce the number of bits in the coded DCT coefficients. Variable length coder 112 is then applied to convert the sequence of coefficients to a serial bit-stream and further reduce the number of bits in the coded DCT coefficients 114.

In order to regenerate the image as seen by a decoder, an inverse variable-length coder 116, an inverse quantizer 118 and an inverse DCT 120 are applied to the coded DCT coefficients 114. This gives a reconstructed difference image 121. The motion compensated version 127 of the previous image is then added at 122 to produce the reconstructed image. The reconstructed image is stored in frame store 128. The previous reconstructed image 129 and the current blocked image 105 are used by motion estimator 124 to determine how the current image should be aligned with the previous reconstructed images so as to minimize the difference between them. Parameters describing this alignment are passed to variable-length coder 130 and the resulting information 132 is packaged or multiplexed with the DCT coefficients 114 and other information to form the final coded image. Motion compensator 126 is used to align the previous reconstructed image and produces motion compensated previous image 127.

In this inter-coding approach, each coded image depends upon the previous reconstructed image, so an error in a single macroblock will affect macroblocks in subsequent frames.

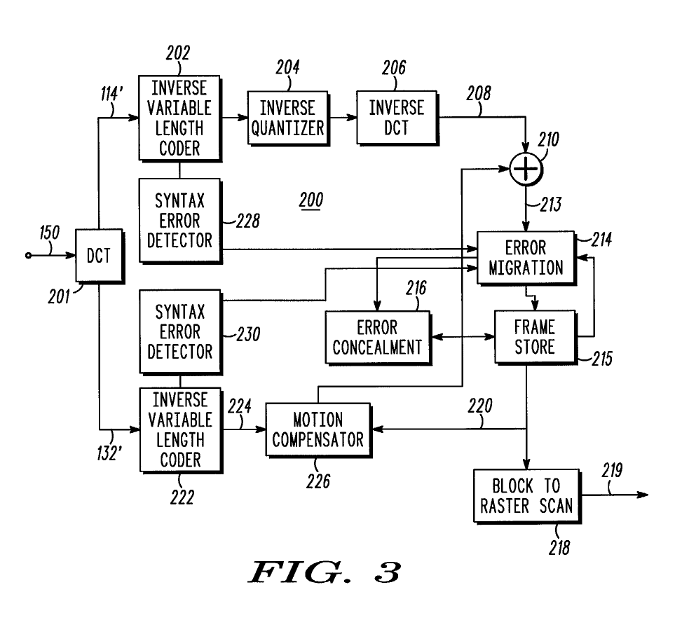

An exemplary decoder 200 is shown in FIG. 3. The input bit-stream 150 may be modified from the bit-stream produced by the coder due to transmission or storage errors that alter the signal. Demultiplexer 201 separates the coefficient data 114′ and the motion vector data 132′ from other information contained in the bit-stream. The input 114′ may be modified from the output 114 from the coder by transmission or storage errors. The image is reconstructed by passing the data through an inverse variable-length coder 202, an inverse quantizer 204 and an inverse DCT 206. This gives the reconstructed difference image 208. The inverse variable-length coder 202 is coupled with a syntax error detector 228 for identifying errors in the coefficient data 114′. The coded motion vector 132′ may be modified from the output 132 from the coder by transmission or storage errors that alter the signal. The coded motion vector is decoded in inverse variable-length coder 222 to give the motion vector 224. Coupled with the inverse variable-length coder 222 is a syntax error detector 230 to detect errors in the coded motion vector data 132′. The previous motion-compensated image, 212, is generated by motion compensator 226 with reference to the previous reconstructed image 220 and the motion vector 224. The motion-compensated version 212 of the previous image is then added at 210 to produce the reconstructed image 213. Error assessment block 214, which constitutes one aspect of the invention, is applied to the reconstructed image 213. Here, the current macroblock is compared with neighboring macroblocks and suspicious macroblocks are labeled. This process is discussed in more detail below. The suspicious macroblocks, and any subsequent macroblocks within the slice, are regenerated by an error concealment unit 216 if errors are identified by either of the syntax error detectors, 228, or 230 or by other information contained in the bit-stream. The error concealment unit 216 may use a strategy such as extrapolating or interpolating from neighboring spatial or temporal macroblocks. The reconstructed macroblocks are stored in frame store 215. The sequence of pixels representing the reconstructed image may then be converted at 218 to a raster scan order to produce a signal 219 that may be presented to a visual display unit for viewing.

In the preferred embodiment, the error suspicion method utilizes macroblocks, but it may also be applied to suspecting errors at a block level. Furthermore, the preferred embodiment employs the sum of absolute differences (SAD) as the error metric. However, other error metrics can be used in this invention. Examples of other error metrics include the mean squared error (MSE), mean absolute difference (MAD), and the maximum absolute difference. It is noted herein that a combination of different types of error metrics, such as SAD in combination with MSE or MAD, for instance, may be used in the present invention. The preferred embodiment takes the SAD along one or more of the macroblock boundaries using one or more of the three channels representing the luminance, Y, and chrominance, Cb and Cr, information. If more than one boundary is used, an average or sum of the SAD values for each boundary is used. A mathematical description of the SAD between the elements of x and y is given as

$$S A D ( x , y ) = {\sum }_{i = 1}^{m} \vert {x}_{i} - {y}_{i} \vert$$

where both x and y are of length m. The elements of the vector x represent the luminance, Y, or chrominance, Cb or Cr, of the pixels along a boundary of the macroblock being checked, while elements of the vector y represent the luminance, Y, or chrominance, Cb or Cr, of the pixels along a boundary of a bordering macroblock.

A large average SAD reflects a greater discrepancy along the border(s) indicating that the current macroblock may have been decoded erroneously. In the preferred embodiment, the method computes an adaptive threshold based upon the contents of previously reconstructed video. The average (or sum) of the SADs along one or more boundaries of the macroblock is compared to this adaptive threshold to decide whether or not the macroblock may have been decoded in error. In determining if the average SAD represents an error, it is compared to an adaptive threshold. In the preferred embodiment, this threshold is computed at the beginning of every frame and is kept constant over the course of the frame, although it can be updated more or less frequently. This threshold is based on a weighted average of the average SADs over a given number of previous frames, defined as n. For example, weighted average of the average SADs for the luminance values is given by

$$\overline{y} = {\sum }_{f = F - n}^{F - 1} w ( f ) {\sum }_{b} S A D ( {x}_{f , b} , {y}_{f , b} ) ,$$

where F is the current frame number, f is an index over previous frames and b is an index over the macroblock boundaries within each frame. w(ƒ) is a weighting factor for frame f, and x_{ƒ,b} and y_{ƒ,b} denote the luminance values for boundary b in frame f.

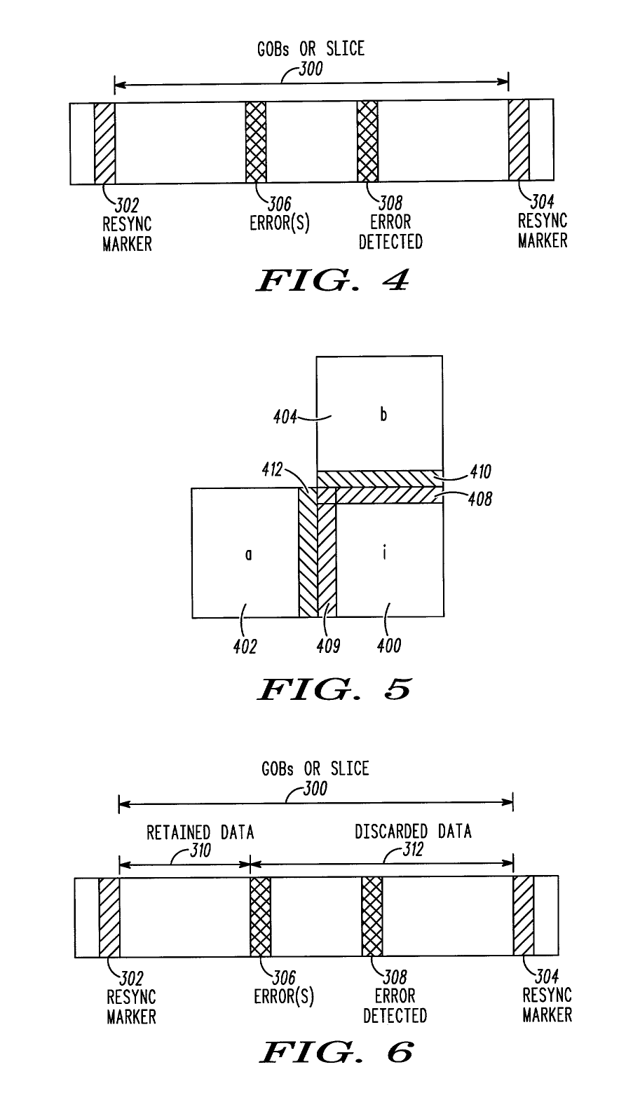

Without limiting the scope of the invention, in the preferred embodiment the average of the SADs along the boundaries is computed using the macroblocks immediately to the left and on top of the current macroblock being processed. This is shown in FIG. 5. In another embodiment more or fewer boundaries may be used. The average SAD for the luminance channel along the left and top boundaries between macroblocks i, a, and b, shown as 400, 402 and 404 in FIG. 5, is defined as

$$Δ \overline{y} = \frac{1}{2} ( S A D ( {i}_{leftcolumn} , {a}_{rightcolumn} ) + S A D ( {i}_{toprow} , {b}_{bottomrow} ) )$$

where SAD(i_{leftcolumn},a_{rightcolumn}) represent the sum of absolute difference between the left column of pixels of macroblock i and the right column of pixels of macroblock a, labeled as 409 and 412, respectively. Equivalently SAD(i_{toprow}, b_{bottomrow}) represents the SAD along the along the top row of macroblocks i and bottom row of macroblock b, labeled as 408 and 410 respectively. The average SAD for the current macroblock for the chrominance channels, Δ\overline{cb} and Δ\overline{cr}, are computed similarly using the data from the respective channels. Each of these SADs is then compared to its corresponding threshold, T_{y}, T_{cb}, and T_{cr}. In the preferred embodiment, if any of the average SAD values exceeds its threshold, the macroblock is labeled as being erroneous or suspicious. An alternative method can label the macroblock as being suspicious or in error if more than one of the three SADs, or a combination thereof, exceeds their respective thresholds.

In the preferred embodiment, the threshold for each channel is calculated once per frame and is based on the average of the average SAD values of all macroblocks over the past three error-free frames. Let \overline{y}, \overline{cb}, and \overline{cr} be the average of the average SAD values of all macroblocks over the past n error-free frames. The thresholds for each of the channels is then given as

T_{y}=α\overline{y}

T_{cb}=β\overline{cb}

T_{cr}=γ\overline{cr}

where α, β, and γ are adjustable weighting values that can be defined by the user or system. Initially, before n error-free frames are available, initial threshold values are used and updated as soon as the frames become available.

The suspicion mechanism can be used in conjunction with the decoder to develop an effective data recovery technique. All data including and beyond the suspicious macroblock can be concealed while data prior to the suspicious macroblock can be retained within an erroneous slice. Referring to FIG. 6, a suspicious macroblock 306 is detected in slice 300. The macroblocks between the suspicious macroblock 306 and the previous resynchronization marker 302 may be assume to be correct and is retained. If a syntax error 308 is encountered within the remainder of the slice 300 before the next resynchronization marker 304, the data between the suspicious block 306 and the resynchronization marker 304 is discarded as being erroneous. If a syntax error is not detected in the remainder of the block, the data may be retained, discarded or subject to further checks. In this manner, the suspicion mechanism may be used as a supportive check. Alternatively, the suspicion mechanism can be used as a definitive check in which if the macroblock is labeled suspicious, an error is flagged and the data discarded immediately.

This invention requires the computation of the SADs along the boundaries of the macroblock and averaging to obtain the average SAD and in computing the adaptive threshold. These steps can be implemented efficiently. Furthermore, the data is checked only once allowing for the possible reuse of some of the SAD results if all boundaries all tested.

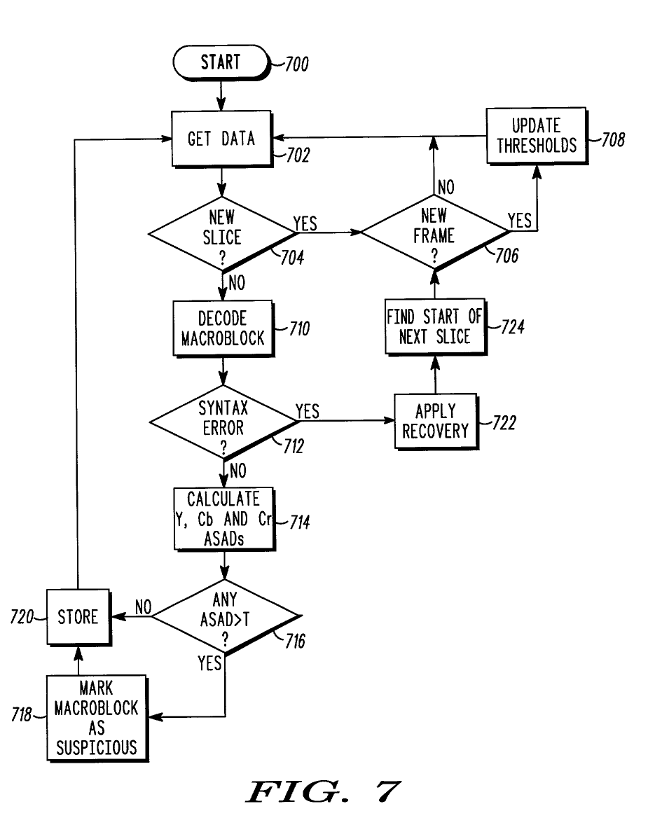

A flow chart depicting the preferred embodiment of the method is shown in FIG. 7. The method begins at start block 700. The current data is retrieved at block 702 and a check is made at decision block 704 to determine if the data corresponds to the start of a new slice. If the data does correspond to the start of a new slice, as depicted by the positive branch from decision block 704, a further check is made at decision block 706 to determine if the data corresponds to the start of a new frame. If not, as depicted by the negative branch from decision block 706, the flow returns to block 702 to get the next data. If it is the start of a new frame, as depicted by the positive branch from decision block 706, the adaptive thresholds are recalculated at block 708 according to the data in previous frames. If the current frame is the first in a sequence of frames, the thresholds are set to predetermined default values. Flow then returns to block 702 where the next data is retrieved. If the data does not indicate the start of a new slice, as depicted by the negative branch from decision block 704, the data is macroblock data, and is decoded at block 710. At decision block 712, a check is made to determine if the data contained syntactical errors (which may have prevented decoding). If syntactical errors were found, as depicted by the positive branch from decision block 712, error concealment or recovery is applied at block 722. The error recovery is applied to all macroblocks between the first suspicious block in the current slice and the end of the current slice, since macroblocks within the current slice may have been inter-coded with reference to the corrupted macroblock. The start of the next slice is detected at block 724, and flow continues to block 702 to determine if the next slice is the first in a new frame. If no syntax errors are detected, as depicted by the negative branch from decision block 712, the average sum of absolute differences (ASADs) for one or more of the luminance and chrominance channels are calculated at block 714. At decision block 716, the one or more ASAD values are compared with the corresponding adapted thresholds. If any of the ASAD values is greater than the corresponding threshold, as depicted by the positive branch from decision block 716, the macroblock is marked as being suspicious at block 718. If none of the values is greater than the corresponding threshold, as depicted by the negative branch from decision block 716, further checks may be performed of the macroblock can be stored at block 720. Flow then continues to block 702, where the next data are retrieved.

The disclosed invention offers benefits in a variety of applications. It is an efficient and adaptive mechanism that allows for errors to be detected within coded video sequences, allowing for good data to be retained. Moreover, the adaptation of the detection thresholds allows detection and recovery to operate with a reduced dependency on the content of the video.

The error detection method described above provides added error resilience for standards based video decoders by recovering data that otherwise would have been lost due to bit errors. This is especially important when transmitting video over wireless channels and the Internet where errors can be severe.

The disclosed method improves decoder performance in a variety of applications, including one-way and two-way video communications, surveillance applications, and video streaming. Other applications will be apparent to those of ordinary skill in the art.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for detecting errors in a digital video signal comprising a sequence of image frames, each image frame comprising a sequence of image slices, each image slice comprising a sequence of macroblocks and each macroblock comprising a plurality of pixels, said method comprising:
detecting the start of an image frame;
updating a threshold level according to data received in at least one previous image frame;
detecting the start of an image slice; and
for each macroblock within the image slice:
calculating one or more error metrics between pixel values of the plurality of pixels along one or more edges of the macroblock and pixel values along corresponding bordering edges of adjoining macroblocks of the image slice; and
labeling as suspicious any macroblock of the image slice for which the one or more error metrics is greater than the threshold level.

2. A method as in claim 1, wherein the pixel values are one or more channel components, wherein an error metric of the one or more error metrics between the pixel values is calculated for one or more of the one or more channel components.

3. A method as in claim 2, wherein the threshold level is updated for one or more of the one or more channel components.

4. A method as in claim 3, wherein a macroblock of the sequence of macroblocks is labeled as suspicious if the one or more error metrics between pixel values for any of the one or more channel components is greater than the threshold level for one or more corresponding channel components.

5. A method as in claim 1, wherein the threshold level is a weighted average of the one or more error metrics in pixel values along macroblock boundaries in at least one previous image frame.

6. A method as in claim 1, further comprising:
if a macroblock of the image slice is labeled as suspicious, regenerating the macroblock and all subsequent macroblocks in the of the sequence of macroblocks of an image slice in accordance with a concealment strategy.

7. A method as in claim 1, further comprising:
detecting syntax errors in the macroblock; and
if a syntax error is detected, further comprising:
retaining those macro blocks within the image slice received prior to all macroblocks of the image slice labeled as suspicious; and
regenerating all remaining macroblocks within the image slice in accordance with a concealment strategy.

8. A method as in claim 1, wherein an error metric of the one or more error metrics is a sum of absolute differences.

9. A system for decoding a digital video signal comprising a sequence of image frames, each image frame comprising a sequence of image slices, each image slice comprising a sequence of macroblocks and each macroblock comprising a plurality of pixels, said system comprising:
an input for receiving said digital video signal;
an image frame store for storing a previous image frame;
a macroblock decoder coupled to the input that receives said digital video signal and to said image frame store; and
an error detector coupled to the macroblock decoder,
wherein said error detector is operable to calculate one or more error metrics between pixel values of the plurality of pixels on at least part of a boundary between a current macroblock and one or more adjoining macroblocks and to label the current macroblock as suspicious if the one or more error metrics is greater than a threshold level which is a weighted average error metric from one or more previous image frames.

10. A system as in claim 9, wherein an error metric of the one or more error metrics is a sum of absolute differences.

11. A system as in claim 9, wherein said macroblock decoder comprises:
a demultiplexer coupled to the input that receives said digital video signal and configured to output compressed, quantized coefficient data and compressed motion vector data;
an inverse variable-length coder coupled to said demultiplexer and configured to output quantized coefficient data and motion vector data;
an inverse quantizer coupled to said inverse variable-length coder and configured to receive said quantized coefficient data and generate coefficient data;
an inverse discrete cosine transformer coupled to the inverse quantizer and configured to receive said coefficient data and generate a differential macroblock;
a motion compensator coupled to said inverse variable-length coder and configured to receive said motion vector data and a previous image frame and generate a previous motion compensated macroblock; and
a signal combiner configured to combine said previous motion compensated macroblock and said differential macroblock to produce a decoded macroblock.

12. A system as in claim 9, further comprising an error concealment element coupled to said error detector and said image frame store.

13. A system as in claim 12, wherein said error concealment element operates to regenerate any subsequent macroblocks in an image slice if the current macroblock is labeled as suspicious.

14. A system as in claim 12, further comprising:
a syntax error detector, which is operable to detect syntax errors in the digital video signal, coupled to the error detector.

15. A system as in claim 14, wherein said error concealment element operates to regenerate any macroblocks in an image slice of the sequence of image slices that follows a macroblock labeled suspicious if a syntax error is detected by said syntax error detector.

16. A system as in claim 9, wherein the pixel values are one or more channel components, wherein the one or more error metrics between the pixel values is calculated for one or more of the one or more channel components.

17. A system as in claim 16, wherein a macroblock is labeled as suspicious if any of the one or more error metrics between the pixel values is greater than the threshold level in one or more corresponding components of the one or more channel components from one or more previous image frames.

18. A device for detecting errors in a digital video signal comprising a sequence of image frames, each image frame comprising a sequence of image slices and each image slice comprising a sequence of macroblocks and each macroblock comprising a plurality of pixels, wherein the device is directed by a computer program that is embedded in at least one of:
(a) a memory;
(b) an application specific integrated circuit;
(c) a digital signal processor; and
(d) a field programmable gate array,
wherein the computer program comprises:
detecting the start of an image frame;
updating a threshold level according to data received in at least one previous image frame;
detecting the start of an image slice; and,
for each macroblock within the image slice:
calculating one or more error metrics between pixel values along one or more edges of the macroblock and pixel values along corresponding bordering edges of adjoining macroblocks;
labeling as suspicious any macroblock for which the one or more error metrics is greater than the threshold level.

19. A device as in claim 18, wherein an error metric of the one or more error metrics is a sum of absolute differences.

20. A device as in claim 18, wherein the pixel values are one or more channel components and wherein an error metric of the one or more error metrics between the pixel values is calculated for one or more of the one or more channel components.

21. A device as in claim 22, wherein the threshold level is updated for one or more of the one or more channel components.

22. A device as in claim 21, wherein a macroblock is labeled as suspicious if the one or more error metrics between pixel values for one or more of the one or more channel components is greater than the threshold level.

23. A device as in claim 18, wherein the threshold level is a weighted average of the one or more error metrics between pixel values along macroblock boundaries in at least one previous image frame.

24. A device as in claim 18, further comprising:
regenerating all remaining macroblocks in accordance with a concealment strategy if a macroblock is labeled as suspicious.

25. A device as in claim 18, further comprising:
detecting syntax errors in the macroblock; and
if a syntax error is detected:
retaining those macroblocks within the image slice received prior to all macroblocks labeled as suspicious; and
regenerating all remaining macroblocks within the image slice in accordance with a concealment strategy.

26. A computer readable medium containing instructions which, when executed on a computer, carry out a process of detecting errors in a digital video signal, said process comprising:
detecting the start of an image frame;
updating a threshold level according to data received in at least one previous image frame;
detecting the start of an image slice; and,
for each macroblock within the image slice:
calculating an error metric between pixel values along one or more edges of the macroblock and pixel values along corresponding bordering edges of adjoining macroblocks; and
labeling as suspicious any macroblock for which the error metric is greater than the threshold level.

27. A computer readable medium as in claim 26, wherein the values of the pixels are one or more channel components, wherein an error metric of the one or more error metrics between the pixel values is calculated for one or more of the one or more channel components.

28. A computer readable medium as in claim 27, wherein the threshold level is updated for one or more of the one or more channel components.

29. A computer readable medium as in claim 27, wherein a macroblock is labeled as suspicious if the one or more error metrics between pixel values for one or more of the first, second, and third channel components is greater than the threshold level.

30. A computer readable medium as in claim 26, wherein the threshold level is a weighted average of the error metric between pixel values along macroblock boundaries in at least one previous image frame.

31. A computer readable medium as in claim 26, wherein said process further comprises:
regenerating all remaining macroblocks are regenerated according to a concealment strategy if a macroblock is labeled as suspicious.

32. A computer readable medium as in claim 26, wherein said process further comprises:
detecting syntax errors in the macroblock; and, if a syntax error is detected:
retaining those macroblocks within the image slice received prior to all macroblocks labeled as suspicious; and
regenerating all remaining macroblocks within the image slice according to a concealment strategy.

33. A computer readable medium as in claim 26, wherein an error metric of the one or more error metrics is a sum of absolute differences.
